(19) United States
(12) Patent Application Publication
(10) Pub. No.: US 2016/0347220 A1
(43) Pub. Date: Dec. 1, 2016

(54) Child Protection Liner

(71) Applicant: Simcha Brown, Cedarhurst, NY (US)

(72) Inventor: Simcha Brown, Cedarhurst, NY (US)

(21) Appl. No.: 15/080,575

(22) Filed: Mar. 24, 2016

Related U.S. Application Data
(63) Continuation-in-part of application No. 14/297,613, filed on Jun. 5, 2014, now abandoned.

(51) Int. Cl. B60N 2/58; B62B 9/14; B60N 2/26; A47C 7/66; A47C 31/11; A47G 9/02

(52) U.S. Cl. CPC B60N 2/5816; A47C 31/11; A47G 9/0223; B60N 2/26; A47C 7/66; B62B 9/142

(57) ABSTRACT

A child protection liner (liner) may be described and disclosed. A child protection liner may include a substrate capable of supporting a child. The child protection liner may have a covering to substantially enclose the substrate. The covering having a top exterior and a bottom exterior, disposed opposite to each other. The liner may have a first fastener with one or more through holes through the substrate and covering, capable of receiving harness hardware from an external support structure to secure the liner to the external support structure. The external support surface may be a car-seat, a stroller, an infant-carrier, or such other child carrying support. The liner may have a second fastener on the covering that may removably attach to at least one blanket. This blanket may contain at least one blanket pocket. This blanket pocket may enclose one or more content-tethers configured to removably attach to one or more articles. The liner may substantially protect the body of the child.

### PRIORITY NOTICE AND CROSS REFERENCE TO RELATED PATENT APPLICATIONS

The present application is a continuation-in-part (CIP) of U.S. patent application Ser. No. 14/297,613 with a filing date of Jun. 5, 2014, which in turn claims priority under 35 U.S.C. §119(e) to U.S. provisional patent application Ser. No. 61/832,044 filed on Jun. 6, 2013, the disclosures of which are both incorporated herein by reference in their entirety as if set forth fully herein.

### TECHNICAL FIELD OF THE INVENTION

The present invention relates in general to child protection devices and more specifically to liners of strollers and the like for protecting infants, toddlers, and animals, including humans, capable of being transported in a stroller, a carrier, or the like.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

As described herein, the term children, or child may include infants, toddlers, young adults, and generally humans of less than one hundred pounds. As described herein, the term caregiver includes parents, grandparents, babysitters, doctors and nurses or anyone or more person who may interact with children on a regular basis. It is well known that children are susceptible to illnesses, and need greater protection from the elements. For example, because of their size children lose body heat more quickly, when exposed to cold air and/or when exposed to rain, when compared with adults, who generally have greater mass. In the case of children, even, exposure to mild weather can result in their bodies losing a lot of heat or too much heat too quickly. It is often desirable to provide a device for protecting the child against the elements. Additionally, children require multiple articles such as toys, strollers, car-seats, infant carriers, feeding bottle, pacifier, water bottles, handheld snacks, handheld food, teething toys, handheld books and the like to transport, entertain, feed and to ease the task of caretakers. Transporting all these articles in addition to transporting the children can be a handful. Moreover, children are known to regularly drop such articles. Lost articles, even when just temporary, are a constant frustration for both the child and their caregivers. Caregivers are distracted from their important tasks by having to search for such dropped and/or lost articles, pacify a frustrated child and the like. A device which minimizes such dropping and/or losses, allows easy access to their articles, and allows self recovery of articles by the child is beneficial to both the child and their caregivers. Finally, the smaller the child, such as infants and toddlers are more prone to injuries, bumps and bruises when they are being transported, because of their inability to communicate, or move their body in response to pain, or to even understand cause and effect. A device which can afford more comfort and better protection from bumps and bruises, when children are transported, will help alleviate these issues.

Therefore, there is a need for a child protection liner, which protects children, such as, but not limited to, infants, toddlers and young adults from the elements, such as wind, rain, snow, heat waves, hailstorms and the like. Securing the children to strollers, car-seats, infant carriers, shopping carts and restaurant chairs comfortably is also a related need. Additionally, there is a need for a compact device to carry one or more essential articles as discussed above, without adding another bag or cart. Finally, there is a need for a device which prevents loss of articles, easy access of articles and self recovery of articles which the children have lost grip of or are interested in.

It is to these ends that the present invention has been developed.

### BRIEF SUMMARY OF THE INVENTION

To minimize the limitations in the prior art, and to minimize other limitations that will be apparent upon reading and understanding the present specification, the present invention describes a child protection liner for attaching to an external support structure, to provide additional protection and/or allow easy storage, transportation and retrieval of articles of children, and minimize loss of those articles. Such, external support structure may include strollers, car-seats, infant carriers, shopping carts, restaurant chairs and the like. Such a child protection liner may be positioned between the child and the external support structure or the child may be placed between a portion of the child protection liner and the external support surface. Such child protection liners may replace existing attachments or devices on the external support structure. For example, a given child protection liner may replace cushions in a child carrier and also serve as a replacement blanket, thus replacing a need for external blankets. The child protection liner may include a substrate capable of supporting a child, having a top exterior and bottom exterior disposed opposite to each other. The child protection liner may be removably attached to the external support structure. The child protection liner may include at least a first fastener capable of receiving a harness-hardware from an external surface to secure the substrate to the external support structure. Additionally, the child protection liner may include at least a second fastener attached to the substrate to attach at least one blanket to the substrate. In one or more embodiments, more than one such blanket may be present. Finally, the substrate may be positioned to: a protect the body of the child and/or to secure the child to the external support structure.

It is an objective of the present invention to provide a child protection liner with storage for one or more of: blankets, rain covers, accessible articles (supplies) required or desired during travel (such as, but not limited to, bottles, drinks, food, toys, pacifiers, and the like.)

It is another objective of the present invention to provide a child protection liner with storage; wherein that storage may be easily and readily wiped clean and/or sanitized.

It is another object of the present invention to provide a child protection liner which is inherently sanitary, as well as providing for sanitary use of bottles, pacifiers, toys, and like such, by storing these articles within a protective pocket or pouch.

It is another objective of the present invention to provide easy access to blankets, pockets, necessary supplies during travel, all in one convenient device.

It is another objective of the present invention to allow children access to items, to keep them entertained, satiated, while allowing the caregivers to focus on other task, e.g., driving or navigating crowded areas with strollers, carriers, car-seats, shopping carts, and the like.

It is another objective of the present invention to prevent or minimize loss of articles and dropping of articles, by using clips, loops, leashes, and the like.

It is another object of the present invention to provide for attachment of the child protection liner to an external support structure, to prevent loss of the child protection liner and to provide proper integration between the child protection liner and the external support structure. The child protection liner may be attached to the external support structure, by use of loops, straps, ties, strings, clips, connectors, fasteners, Velcro®, and the like; through e.g., holes, slits or such in the child protection liner. Additionally, such attachment to an external support structure may protect the child from the elements, such as cold, heat, sunshine, wind, rain, snow, hail, and such.

It is another object of the present invention to provide thermal insulation for food, liquids, including milk and water, for consumption by maintaining desired temperatures. For example, in hot weather, a water bottle may be kept cooler for longer inside a pocket associated with the child protection liner or associated with one or more blankets of the child protection liner.

It is another object of the present invention to at least provide for substantial encapsulation of the child, to provide thermal insulation and protection, comfortable padding and covering, allowing the child to sleep and/or rest warmly and comfortably. In one or more embodiments, the child protection liner may be converted into a sleeping bag like structure, by means of a blanket or cover attached to the substrate, and wrapping the blanket substantially around the child, and fastening the blanket tight using loops, fasteners and holes sewn along its periphery to the substrate. The fasteners used to create this sleeping bag structure may be standalone, attached or independent.

It is an objective of the present invention to provide a substrate placed between the external support structure and the child to provide additional support and/or comfort to the child.

It is another objective of the present invention to provide for a configuration where the child is placed between at least a portion of the substrate and the external support structure.

It is another objective of the present invention to allow use of various external support structures including a car-seat, a stroller, infant-carrier, a shopping cart, and the like.

It is another objective of the present invention, to provide at least one blanket.

It is another objective of the present invention, to provide a blanket made out of an insulating material to protect the child from cold weather.

It is an objective of the present invention, to provide a blanket made out of a hydrophobic material.

It is another objective of the present invention to provide a covering with at least one pocket on the top exterior surface and at least one pocket on the bottom exterior surface.

It is another objective of the present invention to provide a substrate substantially enclosed by a covering material.

It is another objective of the present invention to provide a substrate, wherein the substrate is one or more cushions for supporting the child and/or providing comfort for the child.

It is another objective of the present invention to provide a first fastener which is at least one through hole through the substrate and/or through the covering configured to permit a hardware harness of the external support structure to pass through.

It is another objective of the present invention to provide a second fastener attached to the covering, wherein the cover substantially encloses the substrate.

It is another objective of the present invention to provide a blanket which is made out of two blankets, an inner blanket and an outer blanket.

It is another objective of the present invention to provide that the outer blanket may be completely detached from the inner blanket.

It is another objective of the present invention to provide for the inner blanket to be removably attachable to the outer blanket attached by a third fastener.

It is another objective of the present invention to provide that the third fastener may be selected from one or more of hooks and loop connectors, zippers, snap connectors, buttons, and the like.

It is another objective of the present invention to provide that the one or more blankets may comprise at least one pocket on such blanket(s).

It is another objective of the present invention to provide that the at least one pocket may include at least one content-tether configured to removably attach to one or more articles.

It is another objective of the present invention to provide that the at least one content-tether may comprise a first terminal end and a second terminal end, the first terminal end attached to an inside of the at least one pocket, and where the second terminal end has a content attacher for removably attaching to one or more articles.

It is yet another objective of the present invention to provide a substrate that may be one or more of soft, flexible, semi-rigid, or rigid.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1A may depict an embodiment of a child protection liner, from a perspective view.

FIG. 1B may depict the embodiment of FIG. 1A, as seen from a top view.

FIG. 1C may depict the embodiment of FIG. 1A, as seen from a bottom view (a view disposed opposite from the view of FIG. 1B).

FIG. 1D may depict the embodiment of FIG. 1A, as seen from a front view (which may be a foot end of the child protection liner).

FIG. 1E may depict the embodiment of FIG. 1A, as seen from a back view that is disposed opposite of the view from FIG. 1D (where this back view may be a head end of the child protection liner).

FIG. 1F may depict the embodiment of FIG. 1A, as seen from a left side.

FIG. 1G may depict the embodiment of FIG. 1A, as seen from a right side.

FIG. 1H may depict the embodiment of FIG. 1A, as seen from a bottom perspective view.

FIG. 2 may depict the embodiment of FIG. 1A as seen from a transverse width cross-sectional view along sectional line 2-2, wherein sectional line 2-2 was depicted in FIG. IB.

FIG. 3 may depict the embodiment of FIG. 1A as seen from a longitudinal cross-sectional view along sectional line 3-3, wherein sectional line 3-3 was depicted in FIG. 1C.

FIG. 4 may depict an embodiment of a child protection liner as seen from a top perspective view, with contents of a pocket partially visible, as these contents may be at least partially removed from the pocket.

FIG. 5A may depict a partial view of a blanket with at least one pocket.

FIG. 5B may depict a partial view of a blanket with at least one pocket; wherein the at least one pocket comprises at least one tether that terminates in a content attacher that may removably attach or hold to various articles such as, but not limited to, bottles, pacifiers, and toys, and the like.

FIG. 6A may depict an embodiment illustrating features of a pocket of a child protection liner, specifically a pocket flap attached to a liner covering of the child protection liner.

FIG. 6B may depict an embodiment illustrating features of a pocket of a child protection liner, specifically of a blanket which may be removably stored within that pocket by rolling the blanket into pocket.

FIG. 6C may depict an embodiment illustrating features of a pocket of a child protection liner, specifically where a pocket flap to the pocket may be attached to a blanket removably held within that pocket.

FIG. 6D may depict an embodiment illustrating features of a pocket of a child protection liner, specifically where the pocket may removably close via with snap, a button or the like connector in a middle of a pocket opening.

FIG. 6E may depict an embodiment illustrating features of a using a flap (strap) of a child protection liner, wherein this flap may be used to removably a blanket to a covering of the child protection liner.

FIG. 6F may depict an embodiment illustrating features of a using a flap (strap) of a child protection liner, wherein this flap may be used to removably a blanket to a covering of the child protection liner.

FIG. 6G may depict an embodiment illustrating features use of a snap connector, button, or the like to removably secure a blanket to a covering of the child protection liner.

FIG. 6H may depict an embodiment illustrating features of a pocket of a child protection liner, wherein the pocket that removably stores a blanket may utilize a flap (strap) for removable pocket closure.

FIG. 7A may depict an embodiment illustrating a short rain cover in use on an external support structure, i.e., a stroller, with a flap for attachments and elastic bands for removable securing of the short rain cover to the external support structure.

FIG. 7B may depict an embodiment illustrating a short rain cover in use on an external support structure, i.e., a stroller with an open window and an elastic band or string at a bottom of the short rain cover.

FIG. 7C may depict an embodiment illustrating a long rain cover in use on an external support structure, i.e., a stroller. In some embodiments, this rain cover may comprise a window; and in some embodiments that window may be openable or removable.

FIG. 7D may depict an embodiment illustrating a long rain cover in use on an external support structure, i.e., a stroller, and with a window with breathing holes, and long flap to attach to a child protection liner.

### REFERENCE NUMERAL SCHEDULE

100 child protection liner 100
101 covering 101
104 top exterior surface 104
106 bottom exterior surface 106
110 access slot 110
112 stroller attachment slots 112
114 second fastener 114
116 top pocket 116
118 stroller attachment strap 118
120 pocket opening 120
124 bottom pocket 124
202 substrate 202
308 blanket 308
332 rain cover 332
408 blanket 408
434 liner fastener 434
416 blanket-exterior 416
418 blanket-interior 418
502 blanket pocket 502
504 pocket opening 504
508 blanket 508
510 blanket pocket flap 510
512 tether 512
514 content attacher 514
516 blanket-exterior 516
602 covering 602
608 blanket 608
610 flap 610
612 snap connector 612
614 pocket 614
616 pocket closing flap 616
702 window 702
703 window opening 703
704 window flap 704
706 flap 706
708 elastic band 708
712 rain cover 712
720 window with attachers 720
722 breathing holes 722
728 longer flap 728
735 opening for stroller handles 735
1001 external support structure 1001

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

A child protection liner may be described and disclosed. A child protection liner may include a substrate capable of supporting a child. The child protection liner may have a covering to substantially enclose the substrate. The covering having a top exterior and a bottom exterior, disposed opposite to each other. The child protection liner may have a first fastener with one or more through holes attached to the cushion capable of receiving a harness-hardware from an external support surface to secure the cushion to an external support structure. The external support surface may be a car-seat, a stroller and infant-carrier or such other child carrying support. The second fastener on the covering of the cushion may attach to at least one blanket. The blanket may contain at least one pouch. The blanket may enclose one or more content-tethers configured to attach to one or more articles. The cushion may substantially protect the body of the child. In one or more embodiments the cushion may secure the child to the external support structure.

The child protection liner and pockets may be made of insulted material and easy to wipe material to allow easy cleaning of spills, and food particles. In one or more embodiments, the present invention provides for a storage space for bottles to stand up right. Storage space may include pockets, internal pockets, internal pockets with a clip to hold toys by clipping them. Storage space may include loops. For example, when travelling in a car, children often will have a bottle, toy or pacifier, which they invariably drop and disappears between the seats or under the seats. When attached using a clip or a loop as provided, the child cannot drop the article, and can reach the article again at his or her own convenience.

Such articles may comprise handheld items, i.e., items that may be held in one hand of an infant, a toddler, a child, or a small adult. Such articles may comprise: baby bottles, sippy cups, water bottles, handheld snacks, handheld food, pacifiers, teething toys, handheld toys, handheld books, and the like. The number of articles held (contained) is limited by a size of the at least one pocket-on-blanket and by a size (e.g., surface area) of the blanket.

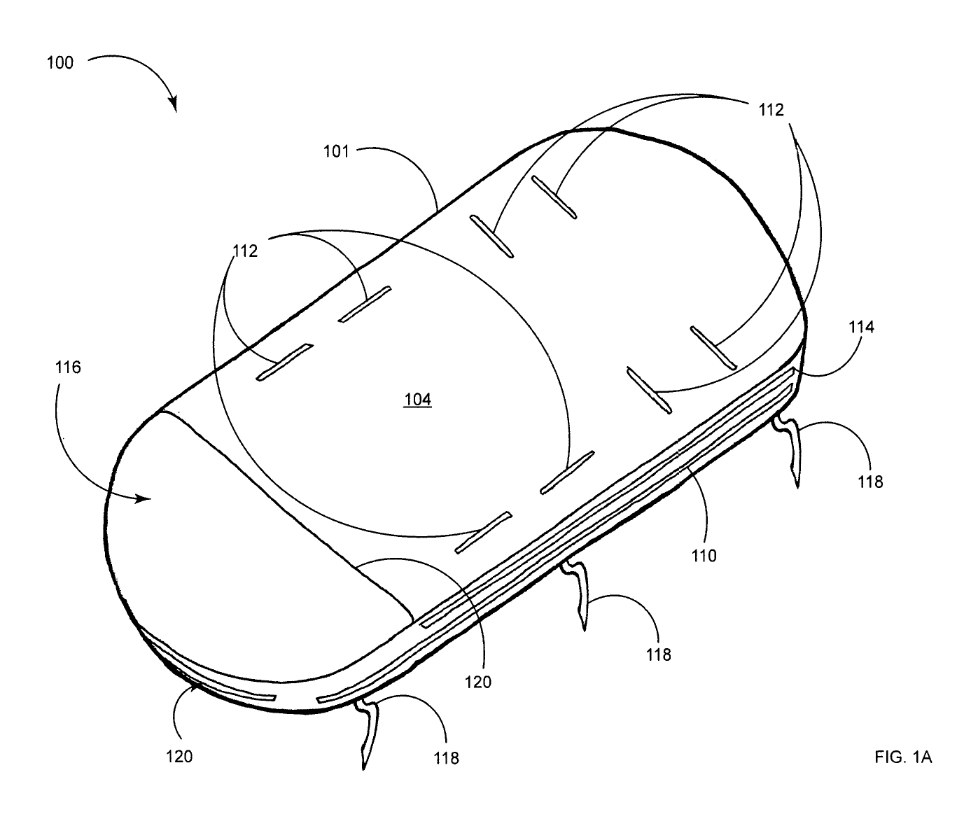

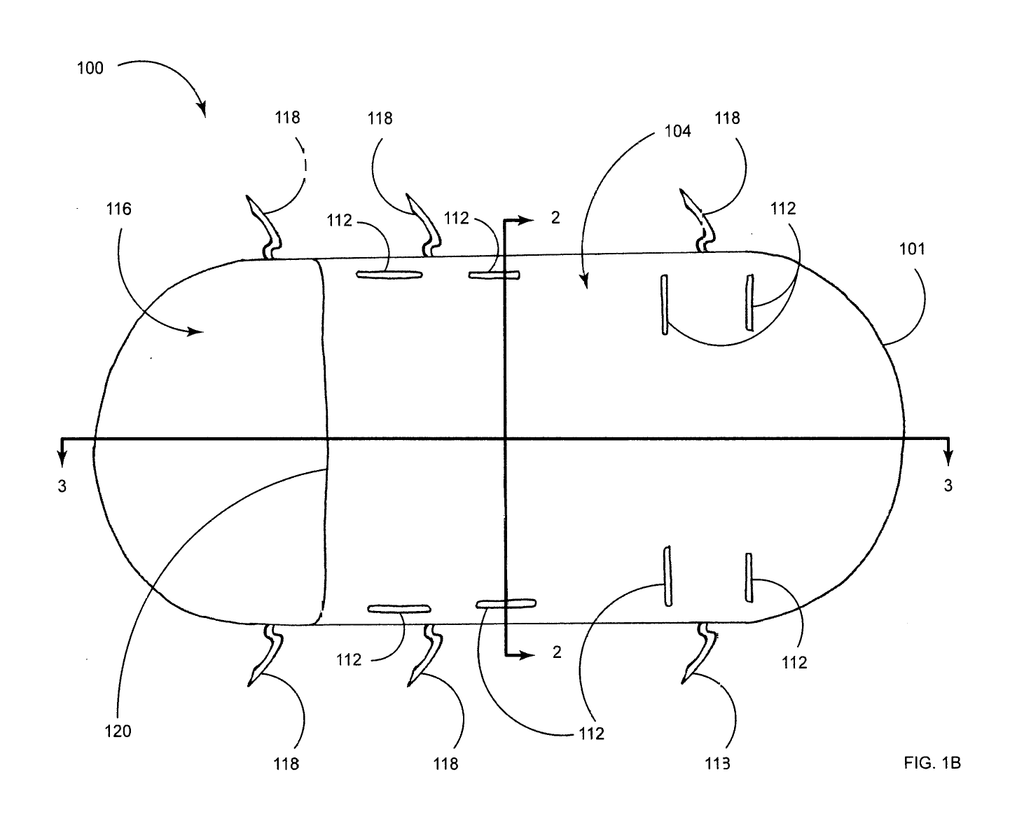

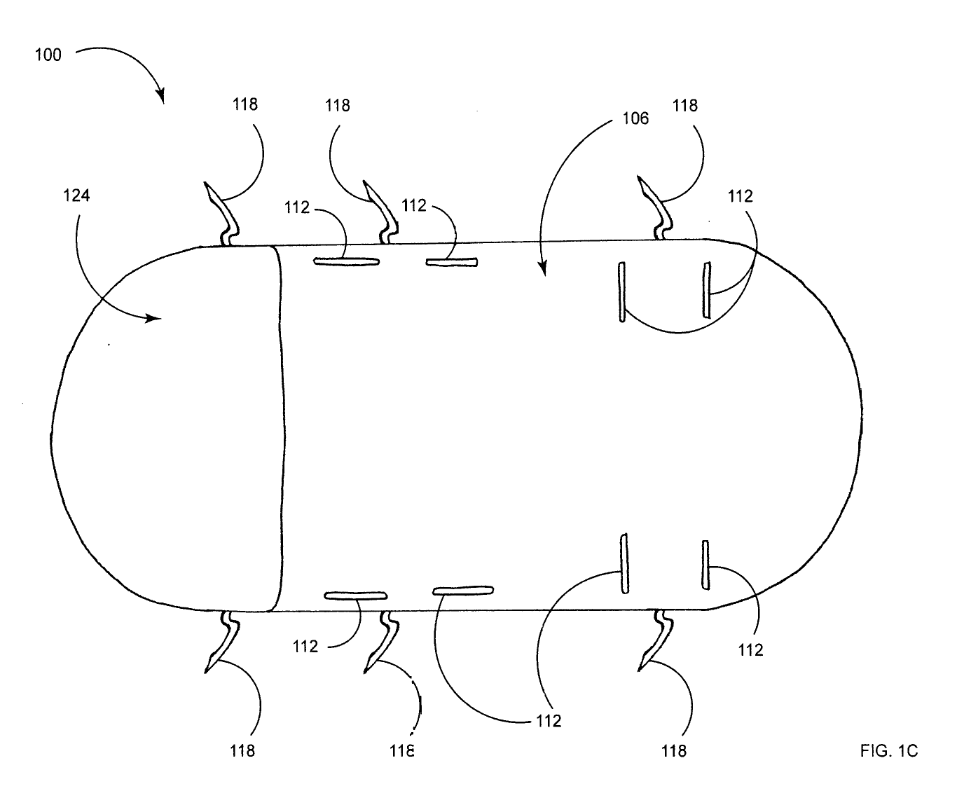

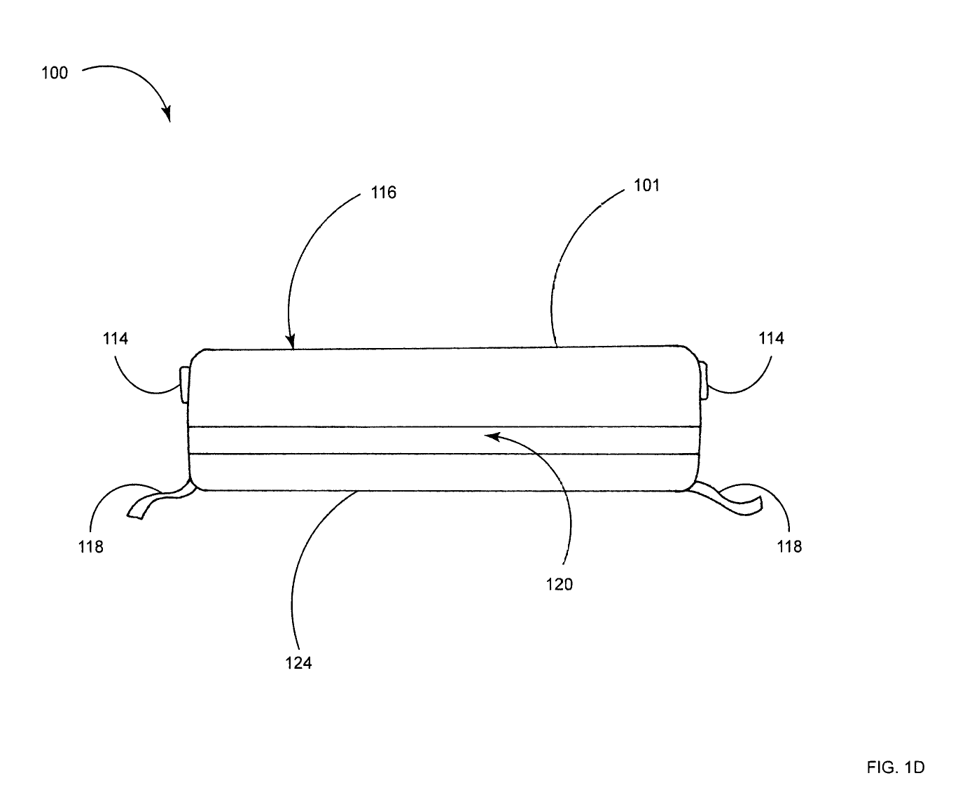

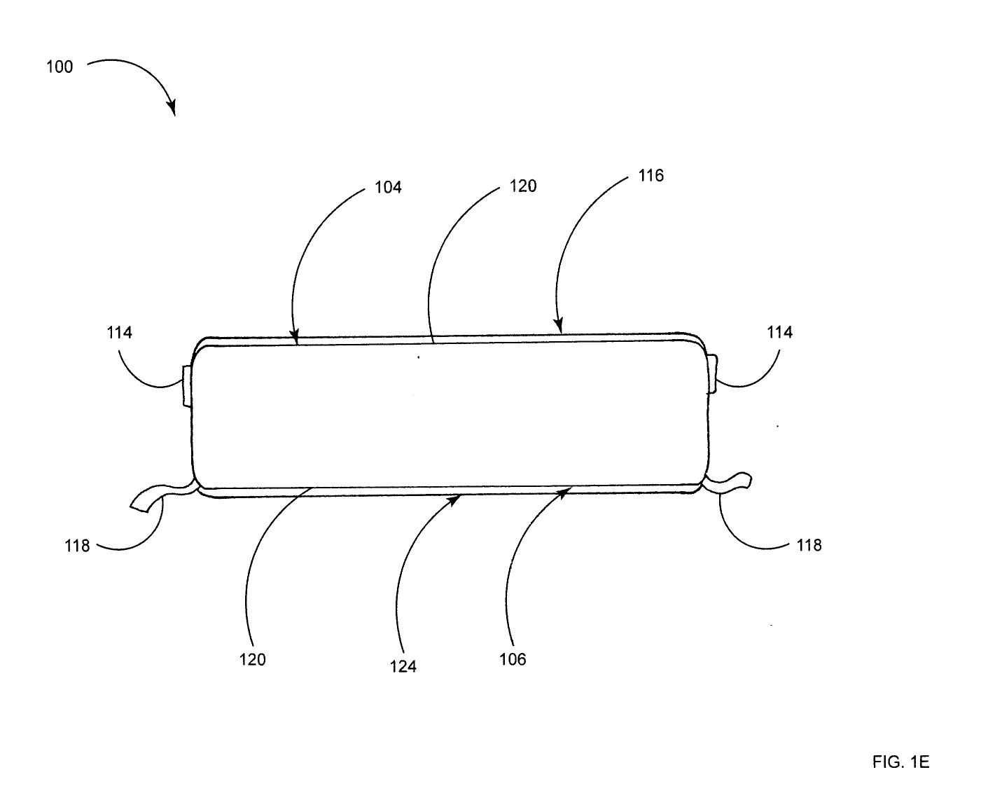

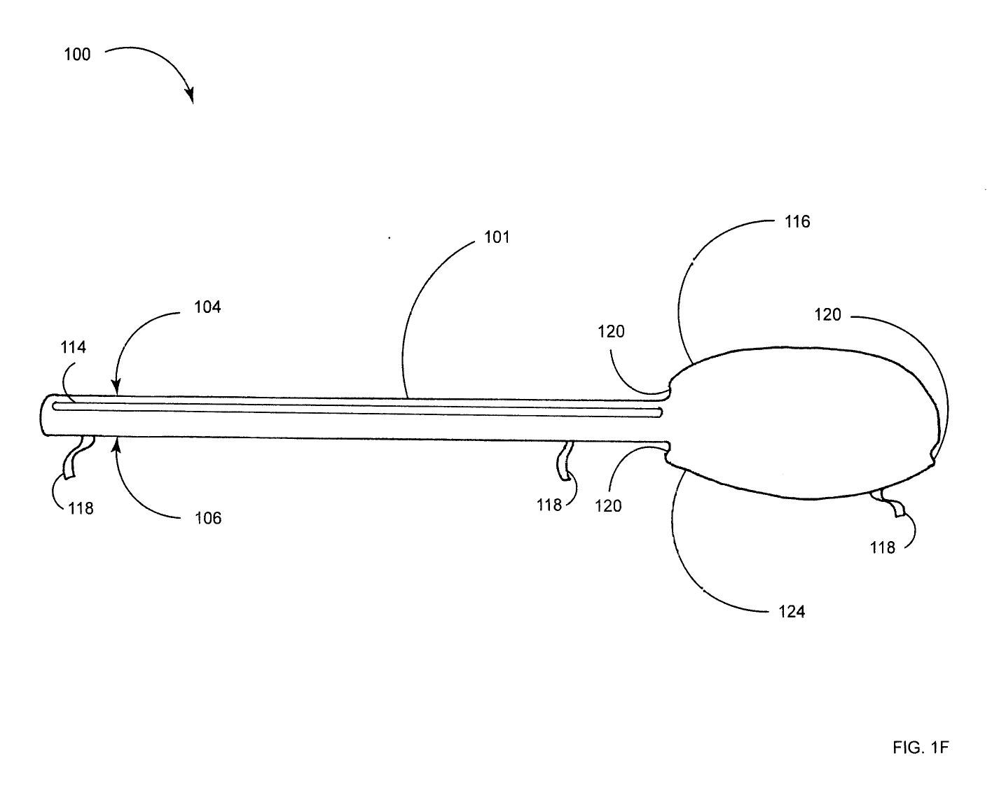

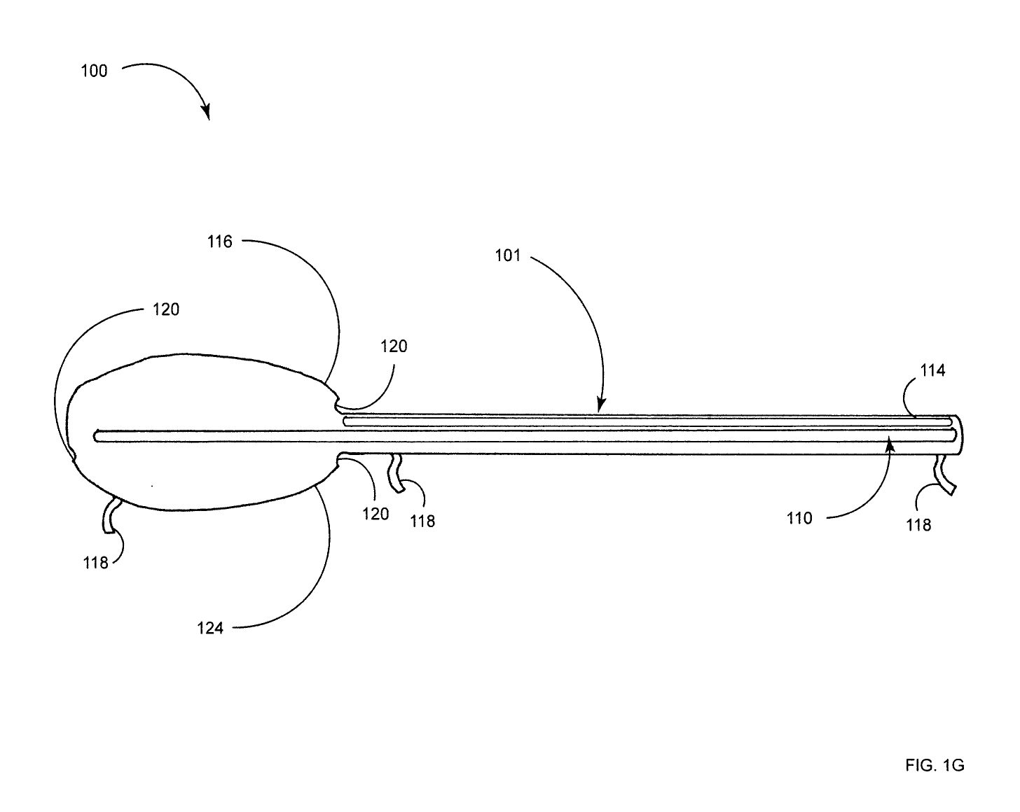

A FIG. 1 series of figures may comprise FIG. 1A through and including FIG. 1H. These FIG. 1 series of figures may depict child protection liner 100 from various views.

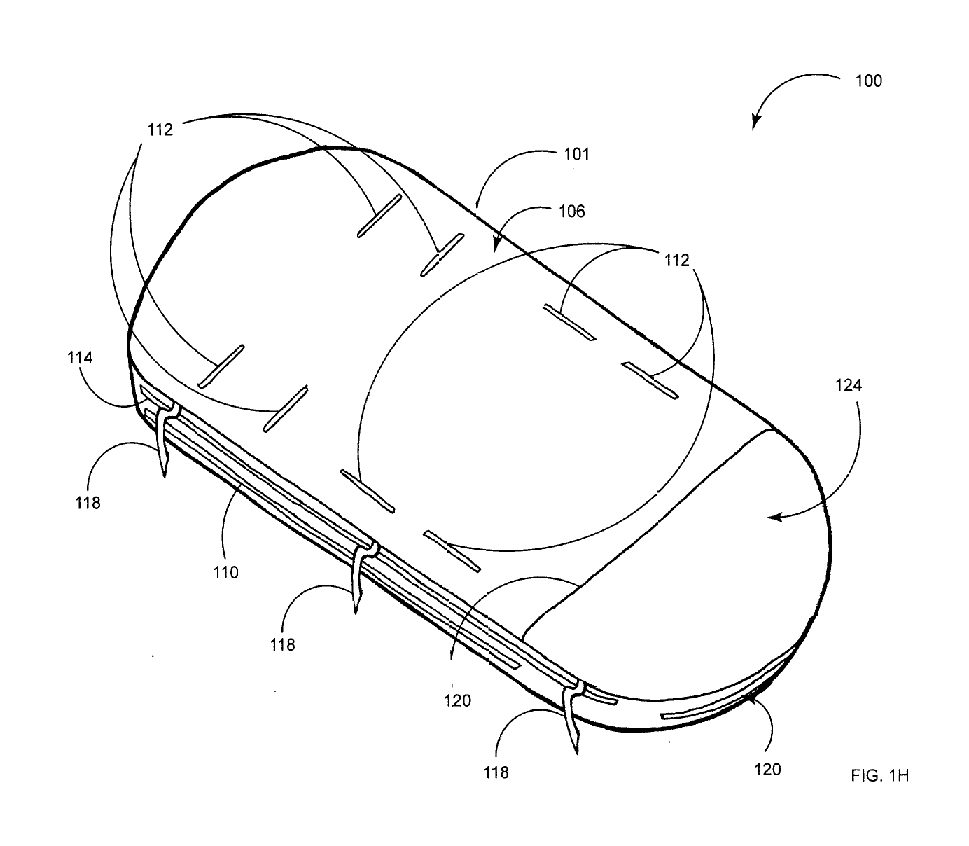

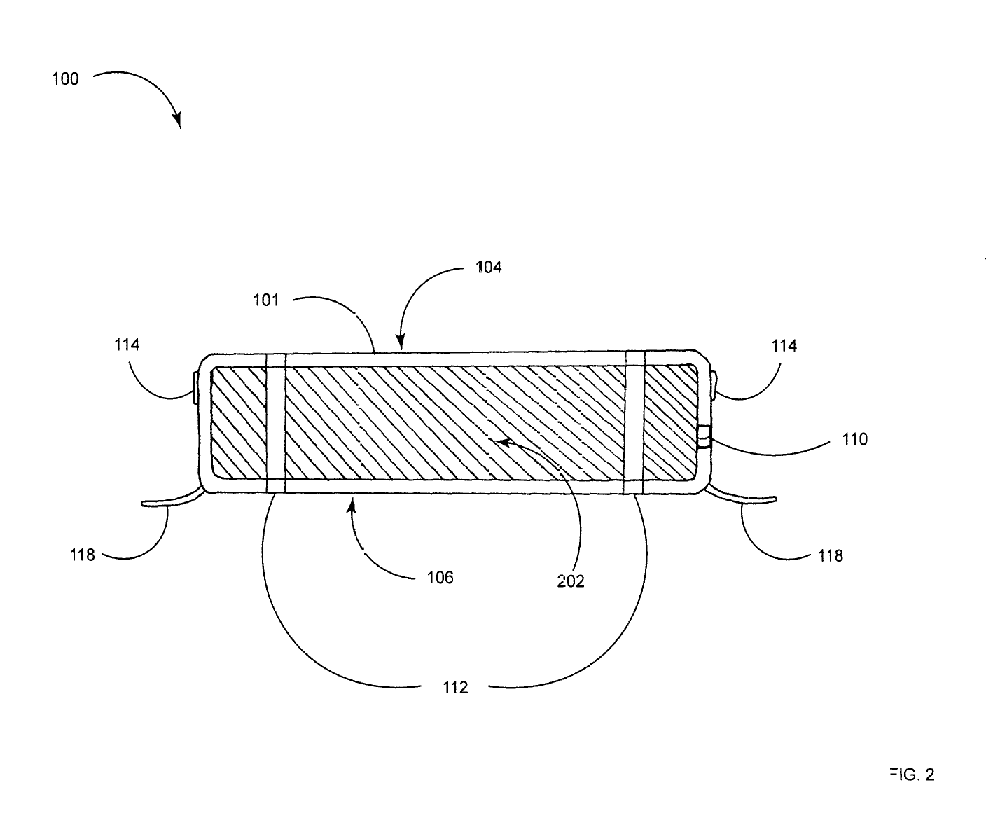

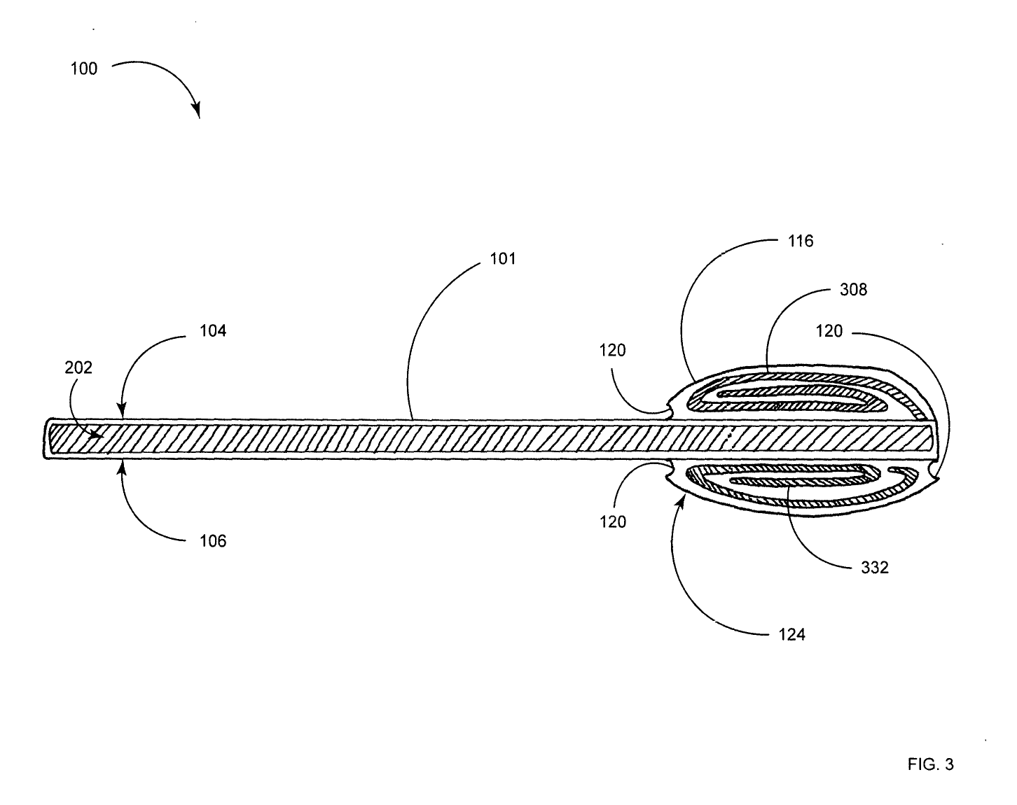

In FIG. 1A, 100 may depict an embodiment of child protection liner 100, as seen from a top perspective view. In one or more embodiments, child protection liner 100 may have a substrate 202 capable of supporting a child. Substrate 202 may be seen in FIG. 2 and in FIG. 3. In one or more embodiments, substrate 202 may be one or more cushions. Substrate 202 may have variable hardness. In some embodiments, substrate 202 may be flexible, semi-rigid, or rigid. In some embodiments, substrate 202 may be a block or one or more blocks of foam, such as, memory foam.

Continuing discussing FIG. 1A, a covering 101 may substantially enclose substrate 202, with a top exterior surface 104 and a bottom exterior surface 106 disposed opposite to each. See FIG. 1H for bottom exterior surface 106. Covering 101 may be soft and/or an insulating material. Covering 101 may be a fabric.

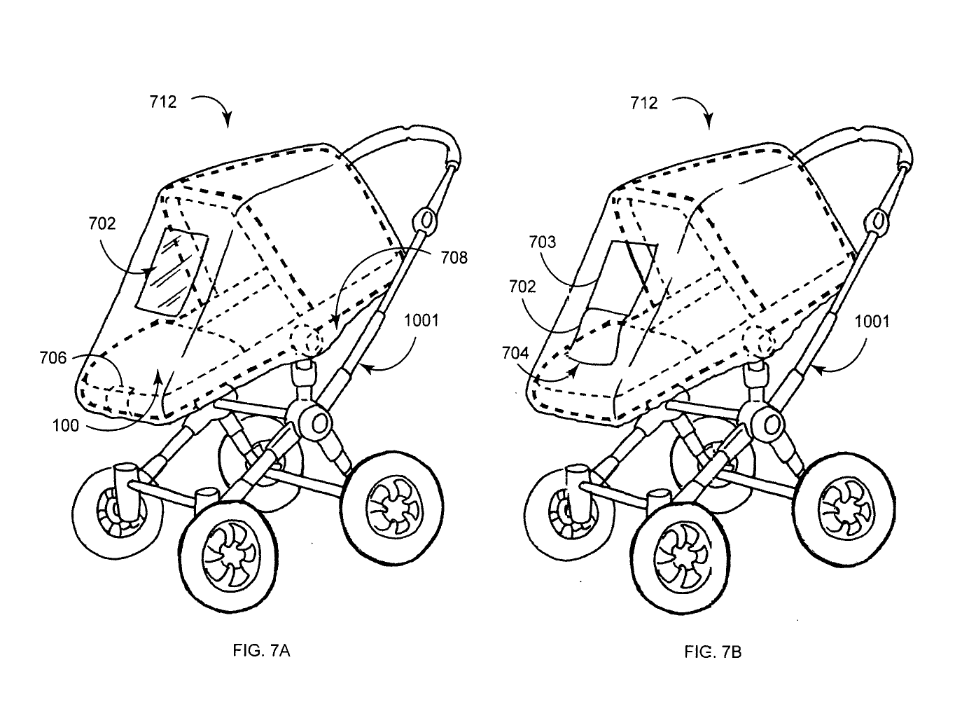

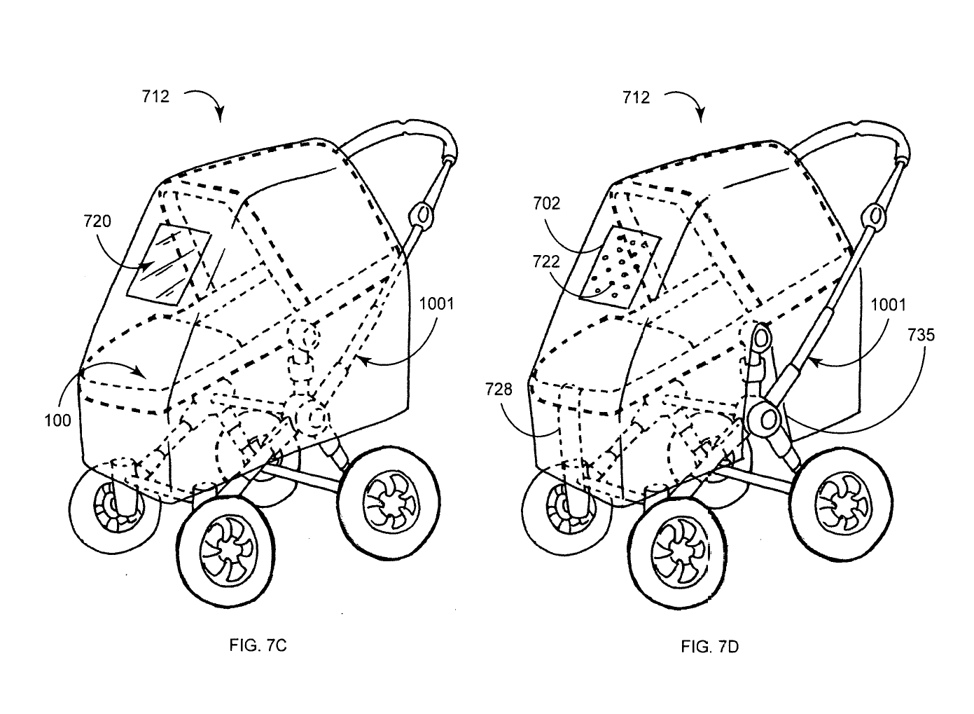

In one or more embodiments, a first fastener 112 or 118 may be attached to substrate 202, capable of receiving harness hardware from an external support structure to secure substrate 202 to the external support structure. Continuing discussing FIG. 1A, in one or more embodiments, this first fastener 112 or 118 may be attached to covering 101 as well as substrate 202, capable of receiving the harness hardware from the external support structure to secure both covering 101 and substrate 202 to the external support structure. In one or more embodiments, this first fastener may be one of stroller attachment slots 112 or stroller attachment straps 118. Stroller attachment slots 112 may be one or more slots that run from top exterior surface 104 of covering 101 to bottom exterior surface 106 of covering 101, passing entirely through substrate 202. See e.g., FIG. 1A, FIG. 1B, FIG. 1C, FIG. 1H, and FIG. 2. Openings around such stroller attachment slots 112 may be sealed, e.g., via a sewn seam. In one or more embodiments, external support structure may comprise strollers, car-seats, infant carriers, shopping carts, restaurant toddler chairs, and the like. An Example, external support structure 1001 is depicted in FIGS. 7A, 7B, 7C and 7D. Note, stroller attachment slots 112 may receive the harness hardware from external support structures other than from strollers.

In some embodiments, the harness hardware may removably secure the child to covering 101 (and/or to substrate 202), as well as removably securing covering 101 (and/or to substrate 202) to the external support structure.

Continuing discussing FIG. 1A, in one or more embodiments, at least a second fastener 114 may be attached to the substrate 202 to engage with at least one blanket (e.g., blanket 308, 408, 508, and 608). In some embodiments, second fastener 114 may be a blanket attachment means. In one or more embodiments, top exterior surface 104 and bottom exterior surface 106 may be enclosed by a covering 101. In some embodiments, covering 101 may comprise top exterior surface 104 and bottom exterior surface 106. FIG. 1A, depicts this configuration from a top perspective view, with an access slot 110 for removing the substrate 202 running along at least one longitudinal side of covering 101. In some embodiments, access slot 110, may be removably sealable via one or more of: a zipper, button, snaps, Velcro®, or the like.

Alternatively, in the case of a substrate 202 without a separate covering 101, the cover may refer to a blanket (not shown in FIG. 1A, but disclosed in FIG. 4) attached the substrate 202, which may be wrapped substantially around a child to create a sleeping bag like structure. The substrate 202 when secured to the external support surface protects the child or secures the child to the external support structure. The protection may be one of thermal insulation, protection from adverse environmental factors such as pollen, dust, wind, sunshine, snow, rain, cold, and like.

In one or more embodiments, substrate 202 maybe a cushion or one or more cushions. The cushion may be configured to provide comfort for the child sitting or lying on top of the cushion. The cushion may be comprised of a foam typically used in the construction of cushions to support infants, toddlers, and children. The cushion may be substantially constructed of a memory foam (e.g., a viscoelastic polyurethane foam, low-resilience polyurethane foam, and the like). The cushion may comprise a three-dimensional shape configured to fit to various models and makes of strollers, car-seats (including booster seats), and infant-carriers. In some embodiments, the cushion may comprise a plurality of cushions. In some embodiments, the cushion may comprise a plurality of foam inserts.

In one or more embodiments, child protection liner 100 may be placed between a surface of the external support structure and the child to provide additional support to the child. Alternately, the child may be placed between child protection liner 100 and the external support surface. In some embodiments, the entire child protection liner 100 may be irremovably placed with respect to the external support structure.

In one or more embodiments, substrate 202 may be placed between the surface of the external support structure and the child to provide additional support to the child. Alternately, the child may be placed between substrate 202 and the surface of the external support structure. In either of these configurations, a blanket may be securely wrapped substantially around the child, either on the front or back of the child, as the case may be.

Continuing discussing FIG. 1A, in one or more embodiments, covering 101 may have one or more pockets 116. In one or more embodiments, covering 101 may have one or more pockets 224. Any such given pocket 116 and/or 124 may have at least one pocket opening 120. Pocket 116 may be seen in FIG. 1A and pocket 124 may be seen in FIG. 1H.

Continuing discussing FIG. 1A, covering 101 may substantially cover substrate 202. Covering 101 may comprise an exterior-surface. This exterior-surface may comprise top exterior surface 104 and bottom exterior surface 106. In some embodiments, the exterior-surface may be waterproof and/or windproof. In such embodiments, child protection liner 100 may assist in protecting strollers, car-seats, and infant-carriers from the elements. Covering 101 may comprise the exterior-surface and an interior-surface disposed opposite of the exterior-surface. The interior-surface may be in communication with substrate 202. See e.g., FIG. 2 and FIG. 3.

Continuing discussing FIG. 1A, first fastener or stroller attachment slots 112 may be configured to removably receive the harness hardware of the stroller, the car-seat, the infant-carrier, or the like. The harness-hardware may function to removably secure the child to the stroller, the car-seat, or the infant-carrier. This harness hardware may be a component of the stroller, the car-seat, or the infant-carrier. This harness hardware may comprise a pair of shoulder straps, a groin strap, and a locking mechanism for locking the shoulder straps and groin strap together on a tummy side of the child, when the child sits (lays) in the stroller, the car-seat, or the infant-carrier.

In some embodiments, stroller attachment slots 112 may comprise a plurality of holes and/or a plurality of slots. These plurality of holes and/or the plurality of slots may each pass through substrate 202 (e.g., the cushion), running from top exterior surface 104 to a disposed opposite bottom exterior surface 106 of covering 101. These plurality of holes and/or the plurality of slots may be configured to permit removable passage of the harness hardware through the plurality of holes and/or the plurality of slots.

Continuing discussing FIG. 1A, second fastener 114 may be configured to permit removable attachment of a blanket (e.g., blanket 308, 408, 508, and 608 to be discussed further below or another blanket) to covering 101 or to substrate 202. In some embodiments, second fastener 114 may be located substantially along a periphery (e.g. edges or sides) of covering 101 or of substrate 202. In some embodiments, second fastener 114 may be located substantially along two opposing longitudinal edges or sides of covering 101 or of substrate 202. As depicted in FIG. 1A, FIG. 1F, FIG. 1G, and in FIG. 1H, second fastener 114 may run longitudinally along two opposing edges (sides) of covering 101. Second fastener 114 may be selected from one or more of a system of a plurality of hooks and a plurality of complimentary loops (i.e., Velcro®), zippers, snap connectors, buttons, and the like. For example, and without limiting the scope of the present invention, second-fastener 106 may comprise alternating regions of plurality of hooks and then plurality of loops along the periphery, such that corresponding complimentary alternating regions of plurality of loop and plurality of hooks located along the edges of the blanket (see e.g., liner fastener 434 in FIG. 4) may removably attach to second fastener 114.

FIG. 1B may depict child protection liner 100, as seen from the top. In one or more embodiments, covering 101 may have top pocket 116 on the top of covering 101. In one or more embodiments, covering 101 may have top pocket 116 on the top of top exterior surface 104. Pocket 116 may be accessible via pocket opening 120. Pocket 116 may be removably sealable via one or more of a system of a plurality of hooks and a plurality of complimentary loops (i.e., Velcro®), zippers, snap connectors, buttons, and the like. Pocket 116 may store a blanket (e.g., blanket 308, 408, 508, and 608). Such blankets may be entirely removable from pocket 116 or in some embodiments, a portion of such blankets may be permanently attached to pocket 116 (such as an inside of pocket 116).

FIG. 1B also shows two sectional lines 2-2 and 3-3 to depict additional details of the child protection liner 100 as shown in FIG. 2 and FIG. 3, respectively. These two sectional lines may be substantially perpendicular to each other. Additionally, top exterior surface 104 enclosed by covering 101 and stroller attachment slots 112 are depicted in FIG. 1B.

FIG. 1C may depict child protection liner 100, as seen from the bottom. In one or more embodiments, covering 101 may have a bottom pocket 124. In one or more embodiments, covering 101 may have bottom pocket 124 on a portion of bottom exterior surface 106. Pocket 124 may removably store and/or contain a protective rain cover (e.g., rain cover 332 or 712) or a blanket. Additionally, bottom exterior surface 106 of by covering 101 and stroller attachment slots 112 (which may be the same stroller attachment slots 112 as depicted in FIG. 1B, just viewed from an opposing view) may be depicted in FIG. 1C, as well as a plurality of stroller attachment straps 118 located along longitudinal bottom edges of bottom exterior surface 106. In some embodiments of child protection liner 100, there may be no stroller attachment straps 118, but still stroller attachment slots 112. In some embodiments of child protection liner 100, there may be stroller attachment straps 118 and no stroller attachment slots 112. In some embodiments of child protection liner 100, there may be both stroller attachment straps 118 and stroller attachment slots 112.

FIG. 1D may depict child protection liner 100, as seen from the front or from a foot end of child protection liner 100. In one or more embodiments, covering 101 (or substrate 202) may have a second fastener 114. Second fastener 114, may be attached to covering 101 along longitudinal sides of covering 101 to removably engage (attach) the at least one blanket (e.g., blanket 308, 408, 508, and 608) to covering 101, to form a sleeping bag like structure with covering 101. Second fastener 114 may removably attach to liner fastener 434, see e.g., FIG. 4. Liner fastener 434 is attached to a given blanket embodiment. Second fastener 114 may be one or more of: a plurality of hooks or a plurality of complimentary loops (i.e., Velcro®), zippers, snap connectors, buttons, and the like. Liner fastener 434 may be one or more of: a plurality of hooks or a plurality of complimentary loops (i.e., Velcro®), zippers, snap connectors, buttons, and the like, such that liner fastener 434 may be complimentary with second fastener 114. Covering 101 on its sides may have one or more (or a plurality) of stroller attachment straps 118. Stroller attachment straps 118 may be used to securely and removably engage (attach) covering 101 to the external support structure.

In some embodiments, second fastener 114, may be attached to the substrate 202 to removably engage (attach) the at least one blanket to substrate 202, to form a sleeping bag like structure with substrate 202. Substrate 202 on the sides may have one or more (or a plurality) of stroller attachment straps 118. Stroller attachment straps 118 may be used to securely and removably engage (attach) substrate 202 to the external support structure.

A pocket opening 120 may also be depicted in FIG. 1D. In some embodiments, this pocket opening may be for accessing pocket 124. In some embodiments, this pocket opening 120 may be for accessing substrate 202 within covering 101.

FIG. 1E may depict child protection liner 100, as seen from the back or from a head end of child protection liner 100. FIG. 1E may be an opposing view as compared against FIG. 1D. As noted above, in one or more embodiments, second fastener 114 may be attached to covering 101 (along its longitudinal sides) or to substrate 202. FIG. 1E may also depict stroller attachment straps 118 that may be used to securely and removably engage (attach) covering 101 (and/or substrate 202) to the external support structure.

FIG. 1F may depict child protection liner 100, as seen from the left side. In one or more embodiments, a top pocket 116 and a bottom pocket 124 may be attached to the top exterior surface 104 and the bottom exterior surface 106, respectively. Either or both pockets 116 and/or 124 may be located more towards a region of cover 101 towards a foot end, i.e., towards the front of child protection liner 100. In some embodiments, child protection liner 100 may comprise one or more top pockets 116 and no bottom pockets. In some embodiments, child protection liner 100 may comprise one or more bottom pockets 124 and no top pockets. In some embodiments, child protection liner 100 may comprise one or more top pockets 116 and one or more bottom pockets 124. Top pocket 116 may have at least one pocket opening 120. Similarly, each bottom pocket 124 may have at least one pocket opening 120. Additional pocket opening 120 may be present elsewhere on the pocket 116 or 124. In some embodiments, pocket opening 120 for top pocket 116 may face towards a head end of child protection liner 100; whereas, in some embodiments, pocket opening 120 for bottom pocket 124 may face towards the foot end of child protection liner 100. In FIG. 1F, at least one second fastener 114 may be present substantially along the longitudinal side of covering 101.

FIG. 1G may depict child protection liner 100, as seen from the right side. In one or more embodiments, access slot 110 may be present to inspect and/or remove substrate 202. Access slot 110 may run substantially along a longitude of covering 101. While access slot 110 may be shown on the right side, in some embodiments, access slot 110 may be located on the left side. In some embodiments, access slot 110 may be located on a foot end or a head end of covering 101 of child protection liner 100. In some embodiments, access slot 110 may removably seal shut by one or more of: a system of a plurality of hooks and a plurality of complimentary loops (i.e., Velcro®), zippers, snap connectors, buttons, and the like.

FIG. 1H may depict child protection liner 100, as seen from the bottom perspective view. FIG. 1H depicts largely the bottom view of child protection liner 100. In one or more embodiments, bottom pocket 124 with one or more pocket openings 120 may be present and attached to covering 101. FIG. 1H also depicts the same stroller attachment slots 112 configured to receive the harness hardware from the external support structure as noted above. Also visible, are one or more stroller attachment straps 118 which may be used instead of, or in addition to, stroller attachment slots 112, to securely engage (attach) covering 101 (and/or substrate 202) to the external support structure. In one or more embodiments, access slot 110 may be present as a component of covering 101, to inspect, insert, and/or remove substrate 202. One or more second fasteners 114 (e.g., blanket attachment means) may be present around the periphery of child protection liner 100.

FIG. 2 may depict child protection liner 100 as seen from a cross-sectional view along sectional line 2-2, of FIG. 1B. FIG. 2 may be a transverse cross-sectional view of child protection liner 100. FIG. 2 depicts stroller attachment slots 112 running completely and entirely through substrate 202, as well as, completely and entirely through covering 101, capable of receiving the harness hardware from the external support structure to removably secure child protection liner 100. Additionally, FIG. 2 depicts substrate 202, which may be one or more cushions, enclosed within covering 101, with an access slot 110 for removing substrate 202. FIG. 2 also depicts one or more second fasteners 114 (e.g., blanket attachment means) to removably secure a given blanket to covering 101 (and/or to substrate 202) along at least the two longitudinal sides of covering 101 or along three sides of a periphery of covering 101. In one or more embodiments, one or more stroller attachment straps 118 may be present attached to bottom locations of covering 101.

FIG. 3 may depict child protection liner 100 as seen from a cross-sectional view along sectional line 3-3 of FIG. 1B. FIG. 3 may be a longitudinal cross-sectional view of child protection liner 100. FIG. 3 may depicts substrate 202 enclosed within covering 101. In one or more embodiments, bottom pocket 124 may be present and attached to a bottom of covering 101. The bottom pocket 124 may removably house a rain cover 332 (and/or rain cover 712). Rain cover 332 or 712 may be completely removable from bottom pocket 124. Bottom pocket 124 may be accessible from one or more pocket openings 120. In some embodiments, pocket opening 120 for bottom pocket 124 may face towards a foot end of child protection liner 100. In some embodiments, bottom pocket 124 may house a blanket.

Continuing discussing FIG. 3, in one or more embodiments, top pocket 116 may be present on a top of covering 101. The top pocket 116 may house blanket 308. Blanket 308 and any other blanket disclosed herein, may be made out an insulating material to protect the child from cold weather. In another embodiment blanket 308 may be made out a hydrophobic material. In one or more embodiments, blanket 308 may comprise both an inner blanket and an outer blanket. The outer blanket may be wind and/or water proof. The inner blanket may be soft and/or insulating. In use, major surfaces of the inner blanket may substantially face the child; while, the major surfaces of the outer blanket may substantially face away from the child. In one or more embodiments, the inner blanket and the outer blanket may be completely detached from each other. The inner blanket and the outer blanket may be removably attachable to each other by a third fastener, substantially along their peripheries. This third fastener may be one or more of a system of a plurality of hooks and a plurality of complimentary loops (i.e. Velcro®), zippers, snap connectors, buttons, and the like. In one or more embodiments, blanket 308 may have at least one pocket. In one or more embodiments, this at least one pocket on blanket 308 may have at least one content-tether to removably attach to one or more articles. The content-tether may be a flexible elongate member, such as a strap, a rope, a string, cordage, and the like. The content-tether may have a first terminal end and a second terminal end, the first terminal end may be attached to the inside of the pocket on blanket 308. The second terminal end may have a content attacher for removably attaching to one or more articles.

FIG. 4 may depict child protection liner 100 in a state of partial removal of blanket 408 from top pocket 116 from pocket opening 120, from a top perspective view. In one or more embodiments, top pocket 116 may house a blanket 408, when blanket 408 may not be in use. In some embodiments, blanket 408 may comprise blanket-exterior 416 and disposed opposite blanket-interior 418. In some embodiments, blanket 408 may comprise liner fastener 434 located substantially along at least two of blanket 408's longitudinal peripheries (sides) for removable attachment of blanket 408 to second fastener 114. In some embodiments, blanket 408 may comprise liner fastener 434 located substantially along at least three of blanket 408's peripheries (sides) for removable attachment of blanket 408 to second fastener 114. Thus, when each liner fastener 434 is substantially removably attached to each respective second fastener 114, the sleeping back structure may be formed between blanket 408 and top exterior surface 104 of covering 101, with substrate 202 providing a comfortable cushion to the child. In some embodiments, at least a portion of blanket 408 (e.g., a bottom transverse width edge of blanket 408) may be permanently attached to top pocket 116. In some embodiments, blanket 308 shares the structures and functions of blanket 408. In some embodiments, blanket 408 shares the structures and functions of blanket 308.

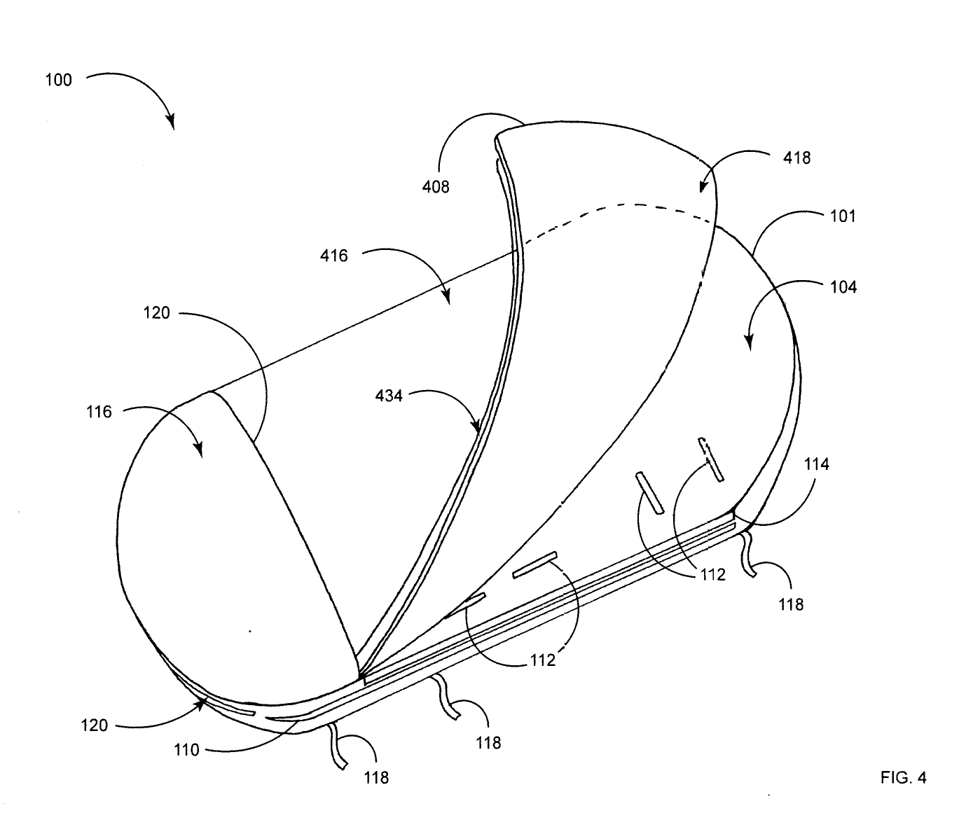

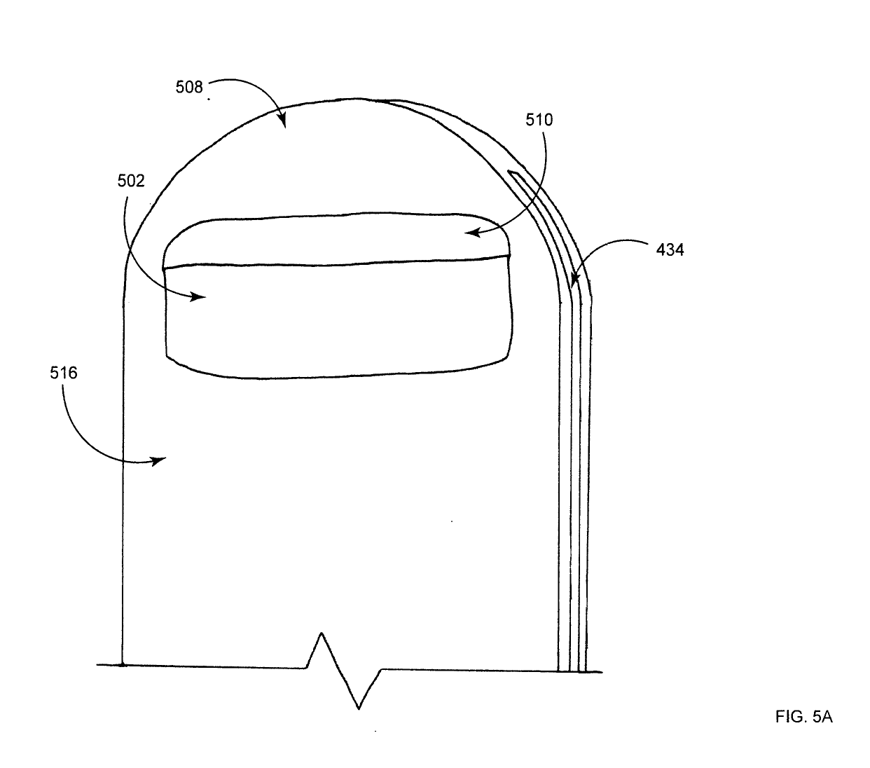

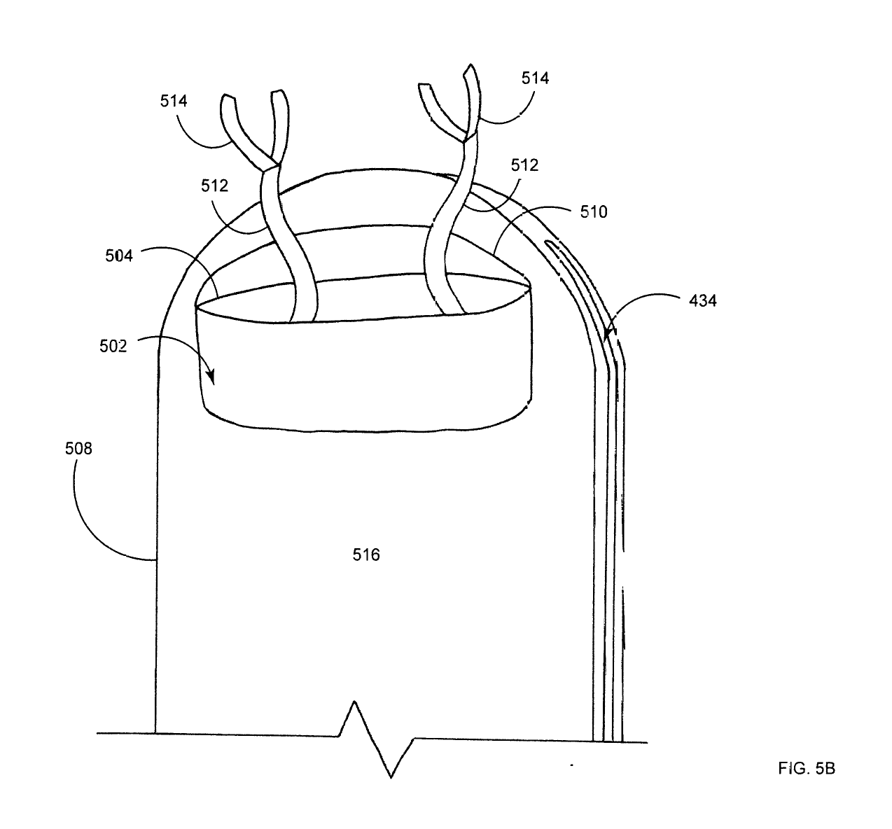

FIG. 5A may depict a partial view of blanket 508, with at least one blanket pocket 502. Blanket 508 is a blanket that may be housed within top pocket 116 and/or in bottom pocket 124. FIG. 5A depicts blanket pocket 502 attached on blanket 508. In some embodiments, blanket pocket 502 may comprise a blanket pocket flap 510, for securely closing the blanket pocket 502. Also depicted in FIG. 5A is liner fastener 434 for removable attaching the blanket 508 securely to second fastener 114 of covering 101 (and/or to substrate 502). In some embodiments, blanket 508 may comprise blanket pocket 502. Blanket pocket 502 may be one or more pockets. Blanket-pocket 502 may be in communication with blanket 508. In some embodiments, blanket-pocket 502 may be permanently attached to blanket 508. In such embodiments, blanket 508 and blanket pocket 502 may be a single article of manufacture. In other embodiments, such permanent attachment may be accomplished, depending upon the materials of construction, by stitching, heat welding, ultrasonic welding, solvent bonding, chemical adhesives, and/or the like.

In some embodiments, blanket pocket 502 may be removable from exterior-surface blanket-exterior 516. In such embodiments, blanket pocket 502 may be removably attached to blanket-exterior 516 by attachment means such as a system of a plurality of hooks and a plurality of complimentary loops (i.e. Velcro®), zippers, snap connectors, buttons, and the like.

FIG. 5B may depict further details of blanket pocket 502 for some embodiments. FIG. 5B may depict pocket opening 504 which provides access to blanket pocket 502. In one or more embodiments, blanket pocket 502 on and of blanket 508, may house a tether 512. In some embodiments, tether 512 may be a flexible elongate member, such as a strap, a rope, a string, cordage, and the like. Tether 512 may comprise a first terminal end and a second terminal end. This first terminal end may be attached to the inside of blanket pocket 502. This second terminal end may have a content attacher 514 for removably attaching to one or more articles. In some embodiments, these articles may comprise one or more of: bottles, drinks, beverage containers, pacifiers, toys, food packaging, books, wipes, napkins, wash cloths, and the like. In some embodiments, a second end of tether 512 may be content attacher 514, and a first end of tether 512 may be attached within blanket pocket 502. There may be one or more tethers 512; and thus, one or more content attachers 514.

In some embodiments, at least one blanket pocket 502 may comprise a closure-means. The closure-means may be configured to removably seal pocket opening 504. In some embodiments, the closure-means may be selected from one or more of Velcro®, Ziploc® type fasteners, zippers, snap connectors, clips, hooks, and the like. In some embodiments, the closure-means may additionally comprise blanket pocket flap 510 of material which may removably fold over pocket opening 504.

In some embodiments, a cavity of at least one blanket pocket 502 may comprise a surface-geometry. The surface geometry may be configured to frictionally grip a bottle, such that the surface-geometry may function as a bottle-holder. The surface-geometry may be formed substantially from an elastomeric-material. In some embodiments, the elastomeric-material may be selected from one or more of the material comprising various foams, gels, rubbers (including natural and/or synthetic), silicones, and the like. Such foam materials may be further selected from one or more of the group comprising: Neoprene®, ethylene vinyl acetate (EVA) polypropylene, polyurethane foams, polystyrene (e.g., Styrofoam®), and the like. In such foam materials, a foam density may be varied by choice of formulation to result in desirable compressibility properties. Likewise, with the non-foam elastomeric-materials (e.g., rubber and/or silicone) durometer may be varied by choice of formulation to result in desirable elastomeric properties.

In some embodiments, at least one blanket pocket 502 may comprise an insulated-pocket. The insulated-pocket may function to slow down heating or cooling of articles held within the cavity of at least one blanket pocket 502. The insulated-pocket may be formed by insulating-materials substantially bounding (i.e., surrounding) this cavity at least one blanket pocket 502. The insulating-materials may comprise insulation properties. The insulating-materials may comprise materials with low thermal conductivity that may be typical for insulating beverages in cup holders. In some embodiments, the insulating-materials may be selected from one or more of the group comprising EVA foams, polyurethane foams, polystyrene foams (e.g., Styrofoam®), polypropylene foam, and the like. In some embodiments, the insulating-materials may be selected from one or more of the group comprising Neoprene®, gels, and the like.

Alternatively or in addition to, the insulated-pocket that may be formed by structure bounding this cavity of at least one blanket pocket 502, the structure may encapsulate air pockets substantially around the cavity. For example, and without limiting the scope of the present invention, this structure may comprise a plurality of closed cells, wherein each cell encapsulates air. Such a plurality of cells encapsulating air is well known to function as an insulator.

In some embodiments, blanket 508 may comprise a second-pocket-on-blanket (not depicted). The second-pocket-on-blanket may comprise a second-opening and a second-cavity of that second-pocket-on-blanket. The second-opening may provide access to the second-cavity. The second-cavity may be of a second-volume configured to removably contain articles. The second-pocket-on-blanket may be located in communication with at least one blanket pocket 502. In some embodiments, the second-pocket-on-blanket may be disposed between at least one blanket pocket 502 and blanket-exterior 516. In such embodiments, the second-pocket-on-blanket may be an inner-pocket and at least one blanket pocket 502 may be an external-pocket.

In some embodiments, the second-pocket-on-blanket may comprise a second-closure-means. The second-closure-means may be configured to removably seal the second-opening. In some embodiments, the second-closure-means may be selected from the group comprising Velcro®, Ziploc® type fasteners, zippers, snap connectors, clips, hooks, and the like. In some embodiments, the second-closure-means may additionally comprise a flap of material which may removably fold over the second-opening, similar to blanket pocket flap 510.

In some embodiments, the second-pocket-on-blanket may comprise at least one second-contents-tether. This at least one second-contents-tether may be configured to removably attach articles to the at least one second-contents-tether. The at least one second-contents-tether may comprise a second-tether and a second-contents-attachment-means. The second-tether may comprise a third-terminal-end and a fourth-terminal-end disposed opposite of the third-terminal-end. The fourth-terminal-end may be attached to a second-cavity-surface. The second-cavity-surface may be an exterior surface of the second-cavity, residing within the second-cavity. The second-contents-attachment-means may removably attach articles to the third-terminal-end.

The second-tether may be strapping or cordage. The second-tether may have elastomeric properties, e.g. resembling Bungee® cord elastomeric properties. In some embodiments, the fourth-terminal-end may be either permanently attached to the second-cavity-surface or removably attached to the second-cavity-surface. For example, and without limiting the scope of the present invention, the fourth-terminal-end may be attached to the second-cavity-surface by stitching (e.g., when both the fourth-terminal-end and the second-cavity-surface may be fabric type materials), stapling, riveting, ultrasonic welding, heat welding, solvent bonding, chemical adhesive, and the like.

In some embodiments, the second-contents-attachment-means may be configured to removably attach to one or more articles, wherein articles may be handheld toys. For example and without limiting the scope of the present invention, the second-contents-attachment-means may comprise a ring with a plurality of clips attached to the ring. Each clip of the plurality of clips may removably attach to a given handheld toy. The ring may also be attached to the third-terminal-end. In such embodiments, a single second-contents-attachment-means may removably attach to the plurality of handheld toys.

Regarding attaching at least one blanket pocket 502 and/or the second-pocket-on-blanket to blanket-exterior 516, and/or attaching at least one blanket pocket 502 to the second-pocket-on-blanket, such attachment means may be permanent. In some embodiments, such attachment means may be by stitching, stapling, riveting, ultrasonic welding, heat welding, solvent bonding, chemical adhesive (e.g., gluing), and the like. Obviously, one of ordinary skill in the art will appreciate that some attachment means may be dependent upon the underlying materials of construction to be joined. For example, and without limiting the scope of the present invention, some of the above named attachment means (e.g., ultrasonic welding and solvent bonding) may be more suitable for joining two plastic (or synthetic) materials and not appropriate for joining two or more pieces of cotton fabric.

Regarding attaching at least one blanket pocket 502 and/or the second-pocket-on-blanket to blanket-exterior 516, and/or attaching at least one blanket pocket 502 to the second-pocket-on-blanket, such attachment means may be removable. In some embodiments, such attachment means may be by Velcro®, zippers, snap connectors, buttons, and the like.

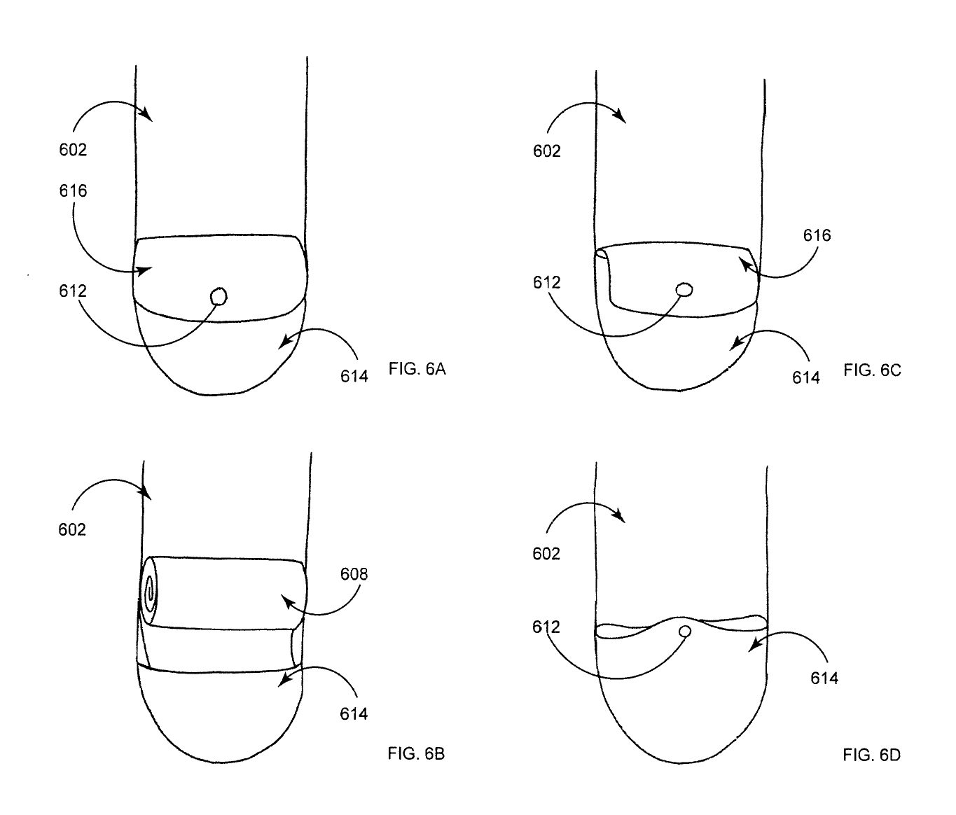

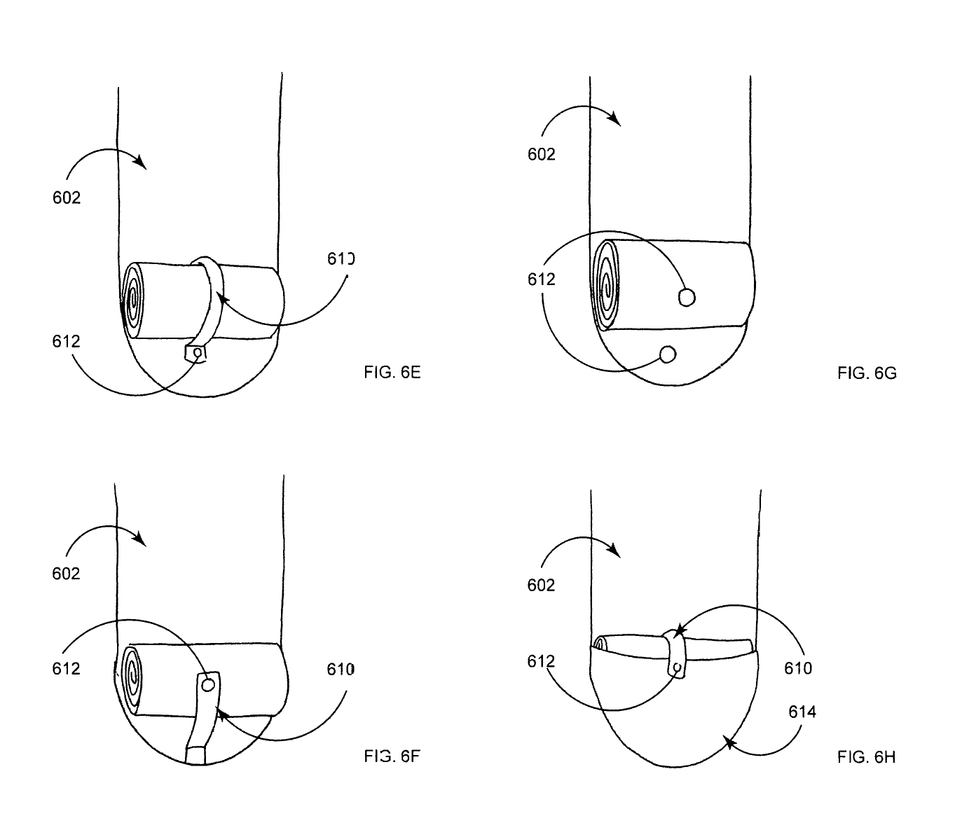

FIG. 6A may depict an embodiment illustrating features of pocket 614, specifically wherein flap 616 may be attached (e.g., sewn) to liner covering 602. In the FIG. 6 series of figures (i.e., FIG. 6A through and including FIG. 6H), covering 101 may be denoted as covering 602. Thus, covering 602 may removably house substrate 202. In one or more embodiments, pocket 614 may have a flap 610 for closing attached (e.g., sewn) to covering 602. Pocket(s) 614 may be for storing of at least one blanket (e.g., blanket 308, 408, 508, and 608).

Pocket 614 may comprise a blanket-cavity and a blanket-pocket-opening. The blanket-cavity may be a volume sized to accommodate a given blanket. The blanket-pocket-opening may be removably sealable by a blanket-pocket-sealing. In some embodiments, blanket-pocket-sealing may be sealed via one or more of a system of a plurality of hooks and a plurality of complimentary loops (i.e., Velcro®), zippers, snap connectors 612, buttons, and the like. In some embodiments, blanket-pocket-sealings may additionally comprise a flap 616 of material which may removably fold over blanket-pocket-opening.

In some embodiments, there may be a plurality of pockets 614 on covering 602. A number (quantity) of pockets 614 that may be located on covering 602 is physically limited by the size of covering 602, i.e., by an available surface area of covering 602.

In some embodiments, blanket 608 may only be partially removable from blanket pocket 614, i.e. blanket 608 may be unfolded or unrolled from blanket pocket 614, such that the child may receive comfort and benefit from blanket 614, but blanket 608 may remain attached along one edge of blanket 608 to the interior of blanket pocket 614.

In some embodiments, attachment between blanket 608 and the interior of blanket pocket 614 may be removable, i.e., blanket 608 may be removable, completely removable, from blanket pocket 614. In such embodiments, blanket 608 may be removably attached to blanket-pocket 614 by attachment means such as a system of a plurality of hooks and a plurality of complimentary loops (i.e. Velcro®), zippers, snap connectors, buttons, and the like.

FIG. 6B may depict an embodiment illustrating rolling of blanket 608 into pocket 614. In one or more embodiments pocket 614 may have a blanket 608 which rolls into pocket 614. In some embodiments, blanket 608 may comprise liner fastener 434 as blanket 408 did and in the same locations. In some embodiments, blanket 608 may be completely removable from pocket 614. In some embodiments, a portion of blanket 608 may be permanently attached to pocket 614.

FIG. 6C may depict an embodiment wherein flap 616 for closing pocket 614 may be attached to blanket 608. That is, flap 616 may be an extension of blanket 608.

Flap 616 may be removably secured (attached) to blanket pocket 614 for closure purposes by one or more of a system of a plurality of hooks and a plurality of complimentary loops (i.e. Velcro®), zippers, snap connectors 612, buttons, and the like.

FIG. 6D may depict an embodiment illustrating features of pocket 614, specifically pocket 614 with snap button 612 in a middle of pocket 614's opening. In one or more embodiments, pocket 614 may comprise snap button 612 located in the middle of pocket 614's opening. The blanket pocket 614 may have a snap button 612 in the middle, removably engaging a top lip of the pocket 614 with a portion of covering 602.

FIG. 6E may depict an embodiment illustrating a flap 610 or strap of material removably securing blanket 608 to covering 602. In some such embodiments, there may be no blanket pockets 614. Or in other embodiments, use of flap 610 to secure a given blanket 608 to covering 602 may be in addition to use of one or more blanket pockets 614. In some embodiments, one end of flap 610 may be attached to blanket 608, and another end of flap 610 may removably attach to covering 602, e.g., via snap connector 612. Or in some embodiments, one end of flap 610 may be attached to covering 602 and the other end of flap 610 may removably attach to covering 602, e.g., via snap connector 612. Flap 610 may wrap around a folded or rolled blanket 608.

FIG. 6F may depict an embodiment where flap 610 may be attached to covering 602 at one end, and the other end, flap 610 may be removably attached to blanket 608, e.g., via snap connector 612.

FIG. 6G may depict an embodiment where snap connector 612 located on blanket 608 and on covering 602 may function to removably secure blanket 608 to covering 602.

In one or more embodiments of the invention, there may be no pockets for enclosing the blankets. The blankets may be attached directly to covering 602 (and/or to substrate 202).

FIG. 6H may depict an embodiment illustrating features of pocket 614, wherein a flap 610 may be used to removably close pocket 614. One end of flap 610 may be attached to covering 602. (Or the one end of flap 610 may be attached to blanket 608.) And the other end of flap 610 may removably attach to pocket 614, e.g., via snap connector 612. In one or more embodiments, blanket 608 may be placed inside pocket 614, with use of snap connector 612 for opening or closing pocket 614. Pocket 614 may be attached to covering 602.

Note, in the FIG. 6 series of figures, snap connector 612 (or snap button 612) may be one or more of: a system of a plurality of hooks and a plurality of complimentary loops (i.e., Velcro®), zippers, snap connectors, buttons, and the like.

A FIG. 7 series of figures may comprise FIG. 7A through and including FIG. 7D. These FIG. 7 series of figures may depict use of rain covers (e.g., rain cover 332 and/or 712) that when not use may be removably stored within bottom pocket 124. Broken lines (dashed lines) within the FIG. 7 series of figures may indicate structure beneath rain cover 712.

FIG. 7A may depict an embodiment illustrating a short rain cover 712 in use on an external support structure 1001, i.e., a stroller with a flap 706 for attachments and elastic bands 708.

In one or more embodiments, of a child protection liner, the bottom pocket 124 may removably contain a short rain cover 712. In use, short rain covers 712 may only cover a top (or upper portion) of external support structure 1001, and protects the baby from rain and other elements. This short rain cover 712 may not cover wheels of external support structure 1001. This short rain cover 712 may be attached to external support structure 1001 by means of an elastic band 708. Elastic band 708 may be located along a major opening of rain cover 712. wrapped around the child protection liner.

In some embodiments, rain cover 712 may be removably stored (contained) within bottom pocket 124. When deployed, rain-cover 712 may be configured to removably and substantially cover upper portions of external support structure 1001 such as a stroller or a child-carrier (e.g., an infant-carrier). Rain-cover 712 may function to protect at least some portions ofe external support structure 1001 from the elements (e.g. from rain, snow, sleet, sunlight, and/or wind), including protecting a user (occupant or rider, e.g., the child) of the external support structure 1001. In some embodiments rain-cover 712 may be substantially constructed of a waterproof and/or a windproof material, such as Gore-Tex® and/or the like.

In some embodiments, rain-cover 712 may comprise an edge-attachment such as elastic band 708 or a pull string located where elastic band 708 may be located. This edge-attachment may be located along a peripheral edges of rain-cover, i.e., at or near or proximate to the major opening of rain cover 712. In some embodiments, each edge-attachment means may be configured to removably attach to one or mroe frame-member(s) of external support structure 1001. Removable attachment of rain-cover 712 to external support structure 1001 may be such that the user (e.g., the child) riding within may receive the benefits of rain-cover 712; i.e., rain-cover 712 may substantially cover the user and at least some portions of external support structure 1001. In some embodiments, this edge-attachment may be one or more of the following hooks, bungees with connectors, Velcro®, zippers, snap connectors, buttons, and the like. In some embodiments, similar edge-attachment-means may also be located on terminal ends of straps, wherein the other end may be attached to the peripheral edges of rain-cover 712. For example, and without limiting the scope of the present invention, the edge attachment may comprise a plurality of hooks wherein each hook may be configured to removably clip onto one or more frame-member(s) of external support structure 1001. For example, and without limiting the scope of the present invention, the edge-attachment-may comprise a plurality of short straps comprising Velcro®, wherein each short strap may be configured to wrap around one or more frame-member(s) of external support structure 1001 such that each short strap may Velcro® to itself. In such embodiments, the short straps may be less than six inches in length. In some embodiments, the straps may be adjustable. Such straps may be flap 706 in FIG. 7A. Flap 706 may also or alternatively removably attach to a given blanket, or to a covering (e.g., 101 and/or 602, and/or to substrate 202.

In some embodiments, rain cover 712 may comprise one or more substantially transparent window(s) 702. Such window(s) 702 may be flexible.

FIG. 7B may depict another embodiment illustrating of a short rain cover 712 in use on external support structure 1001, i.e., the stroller. In the embodiment depicted in FIG. 7B, rain cover 712 may comprise one or more substantially transparent and openable windows 702, such that when window 702 may be open, it may hang down as a window flap 704. This rain cover 712 with an openable window 702 may also comprise elastic band 708 or the pull string at the major opening of rain cover 712. A window opening 703 may be smaller than the major opening of rain cover 712. In one or more embodiments, this short rain cover 712 may have window 702 which may be pulled down as window flap 704 and open to check on the child residing within or to permit more airflow to the child within. In one or more embodiments the pull string may be use in secure the short rain cover 712 around some upper portion of external support structure 1001 and prevent leakage of water into region substantially under rain cover 712.

In some embodiments, rain cover 712 may comprise a window 702. Window 702 may be configured such the user (occupant) may be able to see through window 702. Window 702 may be substantially constructed of a transparent material, such as a transparent plastic.

In some embodiments, rain cover 712 may be replaced with a given blanket comprising a waterproof and/or a windproof exterior surface (e.g., blanket-exterior 516) and wherein liner fastener 434 may be configured to removably attach to one or more frame-members of external support structure 1001, such as a stroller.

FIG. 7C may depict an embodiment illustrating a long rain cover 712 in use on external support structure 1001, i.e., a stroller, and a window with attachers 720. In one or more embodiments, long rain cover 712 may have window which attachers 720 to check on the child or to permit increased airflow. The long rain cover 712 wraps all the way down to at least a vicinity of wheels of external support structure 1001. This may provide for better protection from the elements and mitigate against moisture from affecting most of external support structure 1001, as compared against short rain cover 712 of FIG. 7A and FIG. 7B. The attachers of window with attachers 720 may be one or more of: a plurality of hooks and a plurality of complimentary loops (i.e., Velcro®), zippers, snap connectors, buttons, and the like.

FIG. 7D may depict an embodiment illustrating a long rain cover 712 in use on an external support structure 1001, i.e., a stroller, and a window 702 with breathing holes 722, and long flap 728 to attach to liner (e.g., 100), and slits or openings 735 to accommodate fitting of the stroller handles through. In one or more embodiments, a long rain cover 712 may have a window 702; wherein that window 702 may comprise a plurality of breathing holes 722 for ventilation. The long rain cover 712 may have zipper slits openings 735 for handles. FIG. 7D also illustrates attachment of rain cover 712 to child protection liner 100 via use of longer flap 728. Flap 728 may be functionally similar to strap 706, but just longer.

Note, the devices, such as the child protection liners, described and disclosed herein are not limited to use for children; rather, these devices and structures may also be used for any adults, humans, or any other animal, including humans, that are capable of being transported in a stroller, a carrier, or the like.

A child protection liner has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A child protection liner comprising:
a substrate capable of supporting a child;
a covering to substantially enclose the substrate having a top exterior surface and a bottom exterior surface disposed opposite to each other;
at least a first fastener attached to one or more of the covering or the substrate, capable of receiving harness hardware from an external support structure to removably secure the substrate and the covering to the external support structure; and
at least a second fastener attached to one or more of the covering or the substrate, to removably engage at least one blanket to one or more of the covering or the substrate, wherein the substrate is positioned to protect portions of a body of the child.

2. The child protection liner of claim 1, wherein the substrate is placed below the child to provide additional support between the child and the external support surface.

3. The child protection liner of claim 1, wherein the substrate is one or more cushions for supporting the child.

4. The child protection liner of claim 1, wherein the covering is soft.

5. The child protection liner of claim 1, wherein the first fastener is at least one through hole configured to permit a hardware harness to pass entirely through the covering and the substrate.

6. The child protection liner of claim 1, wherein the covering further comprises at least one pocket on the top exterior surface and at least one pocket on the bottom exterior surface.

7. The child protection liner of claim 6, wherein the at least one pocket on the top exterior surface houses the at least one blanket.

9. The child protection liner of claim 7, wherein the at least one blanket is at least substantially made out of an insulating material to protect the child from cold weather.

10. A child protection liner of claim 7, wherein the blanket is at least made out of a hydrophobic material of at least an exterior surface of the at least one blanket.

11. The child protection liner of claim 7, wherein a portion of the at least one blanket is attached to an inside of the at least one pocket on the top exterior surface.

12. The child protection liner of claim 7, wherein the at least one blanket further comprises an inner blanket and an outer blanket.

13. The child protection liner of claim 7, wherein the at least one blanket further comprises at least one blanket pocket.

14. The child protection liner of claim 13, wherein the at least one blanket pocket further comprises at least one content-tether configured to removably attach to one or more articles.

15. The child protection liner of claim 14, wherein the at least one content-tether has a first terminal end and a second terminal end, the first terminal end attached to an inside of the at least one pocket, the second terminal end has a content attacher for removably attaching to the one or more articles.

16. The child protection liner of claim 6, wherein the at least one pocket on the bottom exterior surface houses one or more of: at least one rain cover or the at least one blanket.

17. A child protection liner comprising:
one or more cushions capable of supporting a child;
a covering substantially enclosing the one or more cushions; wherein the covering has a top exterior surface and a bottom exterior surface disposed opposite to each other; wherein the top exterior surface comprises at least one pocket; wherein the at least one pocket comprises at least one blanket;
at least a first fastener with one or more through holes going entirely through at least one of the one or more cushions and entirely through at least a portion of the top exterior surface and entirely through a at least a portion of the bottom exterior surface; wherein the at least the first fastener receives harness-hardware from an external support structure; wherein the external support structure is one of the following: a car-seat, a stroller, or an infant-carrier; wherein via the harness hardware, the child protection liner is removably secured to the external support structure;
at least a second fastener on the covering for removable attachment of the at least one blanket when the at least one blanket is deployed substantially from the at least one pocket; and
at least one blanket pocket attached to the at least one blanket; wherein the at least one blanket pocket houses one or more content-tethers configured to removably attach to one or more articles;
wherein the one or more cushions substantially protects at least a portion of a body of the child.
